(19) United States
(12) Patent Application Publication
(10) Pub. No.: US 2016/0217145 A1
(43) Pub. Date: Jul. 28, 2016

(54) APPARATUS FOR PROVIDING CONTACT INTERFACE ON WEB PAGE AND METHOD FOR PROVIDING CONTACT INTERFACE

(71) Applicant: NAVER CORPORATION, Seongnam-si (KR)

(72) Inventor: Hyeon Su Jeong, Seongnam-si (KR)

(21) Appl. No.: 15/009,336

(22) Filed: Jan. 28, 2016

(30) Foreign Application Priority Data
Jan. 28, 2015 (KR) 10-2015-0013544

(51) Int. Cl. G06F 17/30; G06F 3/0484; G06F 3/0482

(52) U.S. Cl. CPC G06F 17/3089; G06F 3/0482; G06F 3/04842

(57) ABSTRACT

An apparatus for providing a contact interface comprises a web page provider configured to provide a web page list comprising at least some information of at least one web page to a user terminal; and an additional contact interface provider configured to, when one of the at least one web page is selected, provide additional data corresponding to an additional contact interface provided to be contactable to the owner of the selected web page, to the user terminal.

### CROSS-REFERENCE TO RELATED APPLICATION

This application claims the benefit of Korean Patent Application No. 10-2015-0013544, filed on Jan. 28, 2015, in the Korean Intellectual Property Office, the disclosure of which is incorporated herein in its entirety by reference.

### BACKGROUND

1. Field

One or more embodiments of the present invention relate to an apparatus for providing a contact interface and a method of providing a contact interface by using the apparatus, and more particularly, to an apparatus for providing a contact interface, in which a party may be contacted just by selecting a contact interface displayed together with a web page, even when a user moves to the web page from another web page.

2. Description of the Related Art

Together with rapid development of communication networks, such as the Internet, information retrieval through the communication networks have become generalized. In other words, an internet user can easily obtain required information anytime anywhere by using the Internet, and such information retrieval has changed our lives in general. According to the development of communication and computers, the Internet is used as a popular communication method that transcends borders. Alongside the gradual increase in the number of users using the Internet, services targeting the users are gradually expanding.

A retrieval service using the Internet is a service that finds data matching a keyword by using a search engine. As search engines are becoming enhanced and sophisticated, search algorithms for exposing a web page providing information having public confidence or practical information at the top of search results are being developed.

Portal services providing a retrieval service also provide advertisements matching search words input by users while providing the retrieval service, and such advertisements are also referred to as keyword advertisements.

Information disclosed in this Background section was already known to the inventors before achieving the inventive concept or is technical information acquired in the process of achieving the inventive concept. Therefore, it may contain information that does not form the prior art that is already known to the public in this country.

### SUMMARY

One or more embodiments include an apparatus for providing a contact interface and a method of providing a contact interface by using the apparatus, in which even when a user moves to a new web page from another web page, the owner or operator of the new web page can be contacted just by selecting a contact interface displayed together with the new web page, thereby enabling the user to easily use the new web page.

One or more embodiments include an apparatus for providing a contact interface and a method of providing a contact interface by using the apparatus, in which even when a user moves to a new web page, input information of a contact interface displayed together with the new web page is collected to accurately evaluate an advertising effect of the new web page and provide benefit to an outstanding advertiser, thereby increasing satisfaction of both the user and an advertiser.

One or more embodiments include an apparatus for providing a contact interface and a method of providing a contact interface by using the apparatus, in which when a user contacts an advertiser through a contact interface, a separate guide message is provided to the advertiser such that the advertiser easily determines an inflow route of the user to the advertiser.

Additional aspects will be set forth in part in the description which follows and, in part, will be apparent from the description, or may be learned by practice of the presented embodiments.

According to one or more embodiments, an apparatus for providing a contact interface includes a web page provider configured to provide a web page list including at least some information of at least one web page to a user terminal; and an additional contact interface provider configured to, when one of the at least one web page is selected, provide additional data corresponding to an additional contact interface provided to enable contact with the owner of the selected web page, to the user terminal.

According to one or more embodiments, a user terminal includes a web page displayer configured to display, as a first web page to a user, a web page list comprising some information of at least one web page by using web page data received from an apparatus for providing a contact interface, and to display, when the user selects one of the at least one web page, as a second page different from the first page to the user, the selected web page; and an additional contact interface displayer configured to display, as an upper layer of the selected web page on the second page, an additional contact interface provided to enable contact with the owner of the selected web page by using additional data received from the apparatus.

According to one or more embodiments, a method of providing a contact interface on a web pages includes providing, by an apparatus for providing a contact interface, web page data including a web page list including some information of at least one web page, to a user terminal; when one of the at least one web page is selected, providing, by the apparatus, second web page data corresponding to the selected web page to the user terminal; and providing, by the apparatus, additional data corresponding to an additional contact interface provided to enable contact with the owner of the selected web page, to the user terminal.

According to one or more embodiments, a method of providing a contact interface includes displaying, by a user terminal, as a first page to a user, a web page list including some information of at least one web page by using web page data received from an apparatus for providing a contact interface; when the user selects one of the at least one web page, displaying, by the user terminal, as a second page different from the first page to the user, the selected web page; and displaying, by the user terminal, as an upper layer of the selected web page on the second page, an additional contact interface provided to enable contact with the owner of the selected web page by using additional data received from the apparatus.

According to one or more embodiments, a non-transitory computer-readable recording medium having recorded thereon a program, which when executed by a computer, performs the method of providing a contact interface.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of a system for providing a contact interface, according to an exemplary embodiment;

FIG. 2 is a block diagram of an internal structure of an apparatus for providing a contact interface of FIG. 1;

FIG. 3 is a block diagram of an internal structure of a user terminal of FIG. 1;

FIG. 4 is a flowchart of a method of providing a contact interface, according to an exemplary embodiment; and

FIG. 5 illustrates a screen of the user terminal of FIG. 1, on which an advertising web page is displayed.

### DETAILED DESCRIPTION

Reference will now be made in detail to embodiments of the present invention, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description.

The inventive concept may be embodied in many different forms and accomplished in various embodiments. Thus, embodiments are illustrated in the drawings and described in detail below in the present disclosure. Effects and features of the inventive concept and methods of achieving them would be apparent from embodiments set forth herein, taken in conjunction with the appended drawings. However, the inventive concept is not limited to the following embodiments and may be realized in various forms. In the following embodiments, it will be understood that, although the terms ‘first’, ‘second’, ‘third,’ etc., may be used herein to describe various elements, components, regions, layers and/or sections, these elements, components, regions, layers and/or sections should not be limited by these terms. These terms are only used to distinguish one element, component, region, layer or section from another region, layer or section. Also, the singular forms ‘a’, ‘an’ and ‘the’ are intended to include the plural forms as well, unless the context clearly indicates otherwise. It will be further understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof. For convenience of explanation, in the drawings, the sizes of elements may be exaggerated or decreased. For example, the sizes and thicknesses of elements illustrated in the drawings are arbitrarily determined for convenience of explanation and thus the inventive concept are not limited thereto.

As used herein, the term ‘and/or’ includes any and all combinations of one or more of the associated listed items. Expressions such as ‘at least one of’, when preceding a list of elements, modify the entire list of elements and do not modify the individual elements of the list.

Hereinafter, embodiments will be described in detail, in which like elements are denoted by like reference numerals throughout and are not redundantly described here.

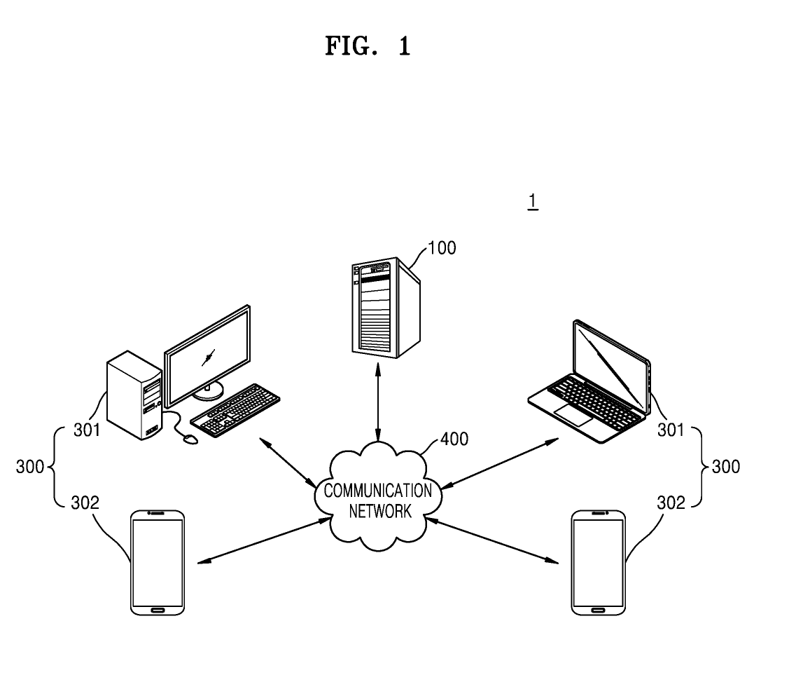

FIG. 1 is a diagram of a system 1 for providing a contact interface, according to an exemplary embodiment.

Referring to FIG. 1, the system 1 according to an embodiment includes an apparatus 100 for providing a contact interface and a plurality of user terminals 300. Also, the system 1 includes a communication network 400 that interconnects the apparatus 100 and the plurality of the user terminals 300.

With respect to displaying of an advertising web page on a user terminal 300, even when a user selects a certain advertising web page from a web page list and a screen of the user terminal 300 is changed from a page of the web page list to a page of the certain advertising web page, the apparatus 100 provides a contact interface (contact shortcut) enabling the user to view contact information included in the certain advertising web page. In this manner, the user may easily contact an advertiser of the certain advertising web page through the contact information even on the page of the certain advertising web page.

While the present invention may be described in the context of online advertisement, e.g., “advertising web page”; “advertiser of the advertising web page,” this is only one embodiment. The present invention may be readily applied to any type of web pages, advertisement or otherwise, thereby enabling the user of a user terminal to contact the owner or operator of a web page through a contact interface provided on the web page,

Here, a contact interface may be a control box displayed on an advertising web page, and may be a touch interface selectable via a touch input of a user. A contact interface is not limited to a touch interface, and may be a voice interface performing a contact operation by recognizing the voice of a user. Hereinafter, an example of a contact interface visually displayed on a web page and selectable via a touch input of a user will be described.

Here, the apparatus 100 according to an embodiment may be a server providing a portal service.

The apparatus 100 may provide not only a contact interface providing service to the user terminals 300, but also an advertisement providing service, a general retrieval service, and other various services increasing user convenience. In other words, the apparatus 100 may provide not only a contact interface providing service but also other various services, such as an advertising service, a retrieval service, an email service, a blog service, a social network service (SNS), a news service, and a shopping information providing service.

Alternatively, the apparatus 100 may be a server connected to a portal service server providing a retrieval service, an email service, a news service, and a shopping service, and configured to provide an advertisement included in a web page provided from the portal service server to a user terminal 300 that requests the portal service server to provide information. Here, the apparatus 100 and the portal service server may be different servers that are physically separated from each other or may be the same server that is conceptually divided.

The contact information included in the advertising web page may be connected through the contact interface provided by the apparatus 100, and at this time, the contact information included in the advertising web page may be a contact number of the advertiser who published and promoted the advertising web page.

The advertising web page that is a target the apparatus 100 provides the contact interface may be provided by an advertising server self-operated by the advertiser who published the advertising web page. The advertising web page may be a website or a blog of the advertiser, or a page of SNS of the advertiser.

The plurality of user terminals 300 refer to communication terminals capable of using a web service in a wire/wireless communication environment. Here, the user terminals 300 may be understood as a personal computer (PC) 301 or a portable terminal 302 belonging to a user. Although FIG. 1 illustrates smart phones as the portable terminals 302, the disclosure is not limited thereto and any terminal having an application capable of web browsing or capable of displaying an advertisement may be used without limitation as described above.

More specifically, examples of the user terminals 300 may include, but are not limited to, computers (e.g., a desktop computer, a laptop computer, a tablet PC, etc.), a media computing platform (e.g., a cable, a satellite set-top box, a digital video recorder, etc.), handheld computing devices (e.g., a personal digital assistant (PDA), an email client, etc.), any type of cellular phones, and other types of computing or communication platforms.

The communication network 400 connects the plurality of user terminals 300 and the apparatus 100 with each other. That is, the communication network 400 refers to a communication network providing an access path via which the plurality of user terminals 300 may access the apparatus 100 to exchange data with the apparatus 100. Examples of the communication network 400 may include wire networks such as local area networks (LANs), wide area networks (WANs), metropolitan area networks (MANs), and integrated service digital networks (ISDNs), and wireless networks such as wireless LANs, CDMA, Bluetooth, and satellite communication, but embodiments are not limited thereto.

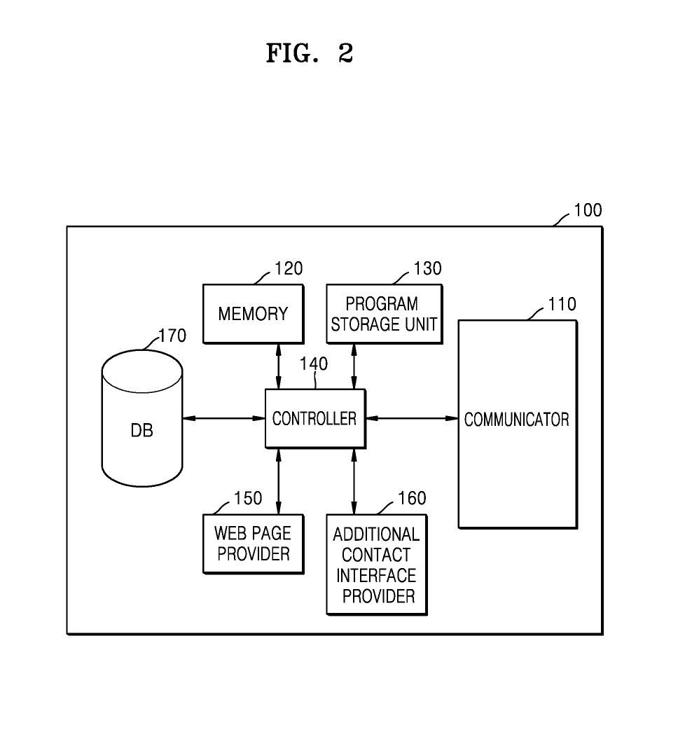

FIG. 2 is a block diagram of the internal structure of the apparatus 100 for providing a contact interface of FIG. 1.

Referring to FIG. 2, the apparatus 100 according to an exemplary embodiment includes a communicator 110, a memory 120, a program storage unit 130, a controller 140, a web page provider 150, an additional contact interface provider 160, and a database (DB) 170.

In detail, the communicator 110 provides a communication interface for providing signals exchanged between the apparatus 100 and the user terminals 300 in a form of packet data, by interworking with the communication network 400. In addition, the communicator 110 may perform a function of receiving an advertising web page providing request from a user terminal 300. Here, the advertising web page providing request received from the user terminal 300 may be a request to provide any type of advertising web page, such as a request to provide a main page or a certain page of a portal site, or a request to provide content included in a certain page.

However, the apparatus 100 may provide the web page list, and the advertising web page selected from the web page list may be a website or a blog of the advertiser or a page of an SNS of the advertiser and may be provided from an advertising server separately from the apparatus 100.

Here, the communicator 110 may be a device including hardware and software needed to access another network device in a wire/wireless manner so as to exchange a signal such as a control signal or a data signal with the other network device.

The memory 120 temporarily or permanently stores data processed by the controller 140. Here, an example of the memory 120 may include a magnetic storage media or a flash storage media but embodiments are not limited thereto.

The program storage unit 130 stores control software for performing the work of calculating a search result according to a user request, the work of generating a web page list by using information about a plurality of advertising web pages, and the work of calculating location information of a contact interface to be displayed on an advertising web page.

The controller 140 is a type of a central processing apparatus, and controls the overall operations of receiving the advertising web page providing request from the user terminals 300 and providing the web page list and the contact interface to the user terminals 300. In other words, the controller 140 drives the control software stored in the program storage unit 130, and upon receiving the advertising web page providing request from the user terminals 300, controls the web page provider 150 and the additional contact interface provider 160 to provide various functions, such as providing the web page list and the contact list to the user terminals 300.

Here, examples of the controller 140 may include various types of devices capable of processing data, e.g., a processor. A processor may be understood to be, for example, a data processing device included in hardware and including circuitry physically configured to perform functions expressed using codes or instructions included in a program. Examples of a data processing device included in hardware as described above may include various processing devices such as a microprocessor, a CPU, a processor core, a multiprocessor, an application-specific integrated circuit (ASIC), a field programmable gate array (FPGA), etc., but embodiments are not limited thereto.

The web page provider 150 and the additional contact interface provider 160 each may be a software program executed by the controller 140, or may be a separate processor controllable by the controller 140.

Upon receiving the advertising web page providing request from a user terminal 300, the web page provider 150 and the additional contact interface provider 160 provide the web page list and the contact interface to the user terminal 300 from the DB 170, under control of the controller 140. Such an operation will now be described.

The web page provider 150 obtains the information of the web page, creates a web page lists using the information obtained, and transmits the web page lists to the user terminal 300.

The additional contact interface provider 160 creates the additional data for the creation of an additional contact interface using the information corresponding to web page selected by the user, and transmits the additional data to the user terminal 300.

According to a general method of providing a contact interface, a contact interface is provided only on a web page list provided by a server, and thus when a user selects a certain advertising web page from the web page list and a screen is changed to the certain advertising web page, the contact interface provided on the web page list is generally no longer displayed. At this time, even when the user wants to access a contact number included in the certain advertising web page while viewing content of the certain advertising web page, formats of advertising web pages of advertisers vary, and thus it is very difficult to directly find the contact number included in the certain advertising web page, thereby inconveniencing the user. Also, after the user moves to the certain advertising web page, behavior, satisfaction, etc. of the user in the certain advertising web page are difficult measure and evaluate. Even for an advertiser, it is difficult to distinguish whether the user contacted the advertiser through the contact number included in the web page list or through the contact number displayed on the certain advertising web page.

Accordingly, the apparatus 100 according to one embodiment adds the contact interface to a screen of the advertising web page even when the user selects the advertising web page from the web page list and the advertising web page is displayed, such that the user may conveniently contact the advertiser through the contact number included on the advertising web page while viewing content of the advertising web page. Also, when the user contacts the advertiser through the contact interface added to the advertising web page, the apparatus 100 may collect history information according to performing of a contact operation and use the history information as an evaluation index of the advertising web page. Also, when the user contacts the advertiser through the web page list or the contact interface included in the advertising web page, the apparatus 100 may separately provide an inflow route guide message to the advertiser such that the advertiser can easily check that the advertiser is contacted through the contact interface.

Accordingly, the apparatus 100 further includes the additional contact interface provider 160.

The additional contact interface provider 160 transmits additional data relating to the contact interface included in the advertising web page to the user terminals 300. The additional data may include contact information and contact method information for enabling contact with the owner or advertiser of the advertising web page.

More specifically, the additional data may include arrangement information for determining a region of the advertising web page the contact interface is to be displayed. For example, the additional data may include blank information of the advertising web page such that the contact interface is automatically provided on a blank region or area of the advertising web page. Accordingly, the user terminals 300 may automatically provide the contact interface on the margin of the advertising web page based on the blank information.

The user terminals 300 receive the additional data and displays the contact interface as an upper layer of the advertising web page on the advertising web page. For example, the contact interface may be generated on a layer separate from the advertising web page, and transparency of the contact interface may be set such that the contact interface does not completely hide content of the advertising web page. At this time, the contact interface may not be restricted to a certain location of the advertising web page, but may move within a screen when the user scrolls the screen. Also, the user may move a location of the contact interface by dragging the contact interface to another location in the screen.

Also, the user terminals 300 may display the contact interface as the upper layer of the advertising web page, in a form of a toolbar of a web browser.

Also, the contact interface may be provided on a blank region or area of the advertising web page while not covering the content of the advertising web page, by using the blank information.

When the user selects the contact interface, the user terminal 300 may perform the contact operation to the contact number included in the advertising web page by using the contact information and the contact method information. Also, when the contact operation is performed, the user terminal 300 may provide the history information to the apparatus 100 such that the apparatus 100 provides the inflow route guide message to the advertiser.

The inflow route guide message is a message notifying the advertiser of a media the user used to contact the advertiser. For example, when the user calls the advertiser by selecting the basic contact interface, the inflow route guide message provided to the advertiser may be ‘call made by clicking phone number in search advertising region (web page list)’ or ‘call made by clicking phone number in “cat adoption” keyword search result (web page list)’, or when the user calls the advertiser by selecting the additional contact interface, the inflow route guide message provided to the advertiser may be ‘call made by clicking additional button on your web page (advertising web page)’.

A method of selecting the contact interface is not limited to a touch input of the user and may vary. For example, the contact interface may be selected by recognizing the voice of the user or by recognizing a shaking operation of the user terminals 300.

Also, the apparatus 100 may distinguish and count the number of times a contact operation is performed through the basic contact interface displayed on the web page list and the number of times a contact operation is performed through the additional contact interface displayed on the advertising web page.

The DB 170 may include a contact interface DB in which contact interface information provided by the apparatus 100 is stored. Here, the contact interface DB may store contact information of an advertiser who publishes and promotes an advertising web page. Also, the contact interface information may include information related to the arrangement of the contact interface to be displayed on the advertising web page and information related to a contact method according to an input on the contact interface, such as phone call connection, instant message transmission, or email transmission.

In addition, the DB 170 may further include a user DB in which user information is stored. Here, the user DB stores user information about a user who is to use a retrieval or advertising service. Here, the user information may include basic information such as the name, the affiliation, personal data, the gender, and the age of the user; login information such as identification (ID) and password; and access information such as access country, access location, access device, and access network environment.

Also, although not shown in FIG. 2, the apparatus 100 according to an embodiment may further include an input/output (I/O) unit.

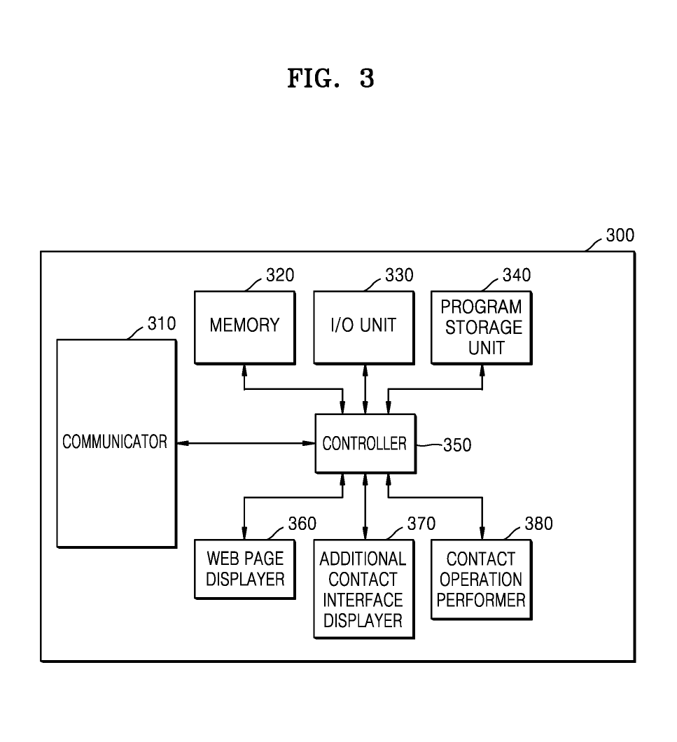

FIG. 3 is a block diagram of the internal structure of the user terminals 300 of FIG. 1.

Referring to FIG. 3, the user terminals 300 of FIG. 1 include a communicator 310, a memory 320, an I/O unit 330, a program storage unit 340, a controller 350, a web page displayer 360, an additional contact interface displayer 370, and a contact operation performer 380.

In detail, the communicator 310 may be a device including hardware and software needed to exchange a control signal or a data signal with another network apparatus, e.g., the apparatus 100, via wired/wireless connection. For example, the communicator 310 may include a short-range wireless communicator or a mobile communicator. Examples of the short-range wireless communicator may include, but are not limited to, a Bluetooth communicator, a Bluetooth low energy (BLE) communicator, a near-field communicator, a WLAN (Wi-Fi) communicator, a Zigbee communicator, an infrared data association ((IrDA) communicator, a Wi-Fi Direct (WFD) communicator, an ultra wideband (UWB) communicator, an Ant+ communicator, etc. The mobile communicator exchanges a radio signal with at least one among a base station, an external terminal, and a server in a mobile communication network. Examples of the radio signal may include various types of data generated during exchange of a voice call signal, a video call signal, or a text/multimedia message.

The memory 320 may temporarily or permanently store data processed by the controller 350 or content data transmitted to the user terminal 300. An example of the memory 320 may include a magnetic storage media or a flash storage media but embodiments are not limited thereto.

The I/O unit 330 may be configured as a touch-recognizing display controller or one of other various I/O controllers. For example, the touch-recognizing display controller provides an output interface and an input interface between an apparatus and a user. The touch-recognizing display controller exchanges an electric signal with the controller 350. Also, the touch-recognizing display controller displays a visual output to the user, wherein the visual output may include text, graphic, an image, a video, or a combination thereof. Such an I/O unit 330 may be, for example, a certain display member, such as an organic light-emitting display (OLED) or liquid crystal display (LCD) capable of touch recognition.

The program storage unit 340 stores control software that performs the work of receiving a search result and a web page list from the apparatus 100, the work of receiving a selection signal on a search result from the I/O unit 330 of the user terminal 300, the work of displaying a contact interface based on location information of the contact interface to be displayed on an advertising web page, the work of receiving a selection signal on a contact interface, and driving of a contact application corresponding to a contact method.

The controller 350 is a type of a central processing apparatus, and controls the overall operations of the user terminal 300 downloading content. In other words, the controller 350 provides various functions, for example, drives the control software included in the program storage unit 340, displays an advertising web page on the user terminal 300 by controlling the web page displayer 360, further displays a contact interface on the user terminal 300 by controlling the additional contact interface displayer 370, and when an input on the contact interface is received, drives a contact application corresponding to a contact method by controlling the contact operation performer 380.

Here, examples of the controller 350 may include various types of devices capable of processing data, e.g., a processor. Here, the processor may be understood as, for example, a data processing device included in hardware and including a circuit physically configured to perform a function expressed using code or instructions included in a program. Examples of the data processing device included in hardware as described above may include various processing devices such as a microprocessor, a CPU, a processor core, a multiprocessor, an application-specific integrated circuit (ASIC), a field programmable gate array (FPGA), etc., but embodiments are not limited thereto.

The web page displayer 360, the additional contact interface displayer 370, and the contact operation performer 380 each may be a software program executed by the controller 350, or may be a separate processor controllable by the controller 350.

The web page displayer 360 and the additional contact interface displayer 370 display the advertising web page to the user by using web page data received from the apparatus 100, and display the contact interface to the user by using additional data received from the apparatus 100, under control of the controller 350.

The web page displayer 360 displays the received web page lists from the contact interface providing apparatus 100 as a first page, and displays the received web page data selected by the user from the contact interface providing apparatus 100 as a second page.

When the second page is displayed, the additional contact interface displayer 370 creates an additional contact interface with additional data received from the contact interface providing apparatus device 100, and displays the additional contact interface as an upper layer of the second page.

If the interface is selected, the contact operation performer 380, transmits information included in the additional data to a contact-related application of the user terminal 300.

The contact operation performer 380 performs a contact operation when the user selects the basic contact interface or the additional contact interface and transmits history information regarding the performing of the contact operation to the apparatus 100, under control of the controller 350.

For example, a method of performing a contact operation may include a phone call method through a phone application, a message transmitting method using an instant messenger, an email transmitting method through an email application, and a message transmitting method through a short message service (SMS).

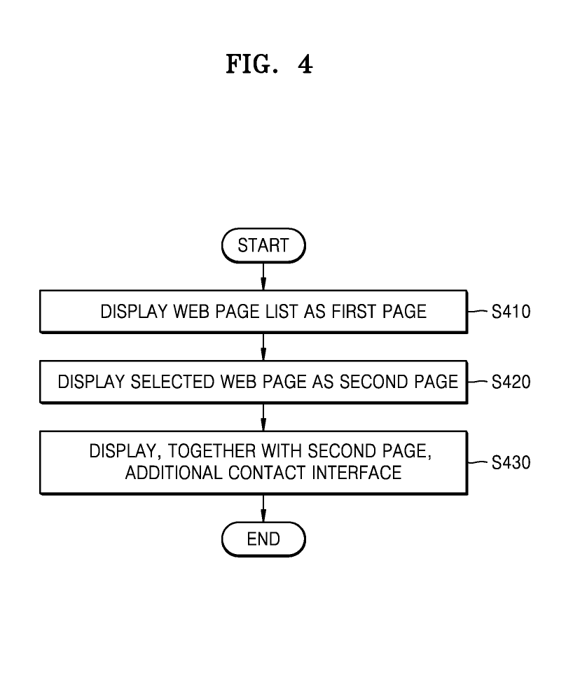

FIG. 4 is a flowchart of a method of providing a contact interface, according to an exemplary embodiment.

Referring to FIG. 4, the method includes displaying, by a user terminal 300, as a first page to a user, a web page list including some information of at least one advertising web page by using web page data received from the apparatus 100 (operation S410). When the user selects an advertising web page from the first page, displaying by the user terminal 300, as a second page different from the first page, the selected advertising web page to the user (operation S420). The user terminal 300 then displays, together with the second page, an additional contact interface provided to enable contact with the advertiser of the selected advertising web page by using additional data received from the apparatus 100 (operation S430).

In more detail, the apparatus 100 first extracts the at least one advertising web page corresponding to a user request, and generates the web page list by using some information of the at least one advertising web page. The apparatus 100 provides the web page list to the user terminal 300 and the user terminal 300 displays the web page list as the first page, in operation S410.

Here, the apparatus 100 may provide information about the at least one advertising web page as the web page data. In other words, the apparatus 100 may provide the web page data including data regarding the advertising web page, such as a title, a summary, a prepared time, an image, a uniform resource locator (URL), and an advertiser name. Here, the apparatus 100 may further provide link information of the at least one advertising web page to the user terminal 300.

Next, when one advertising web page is selected from the web page list displayed on the user terminal 300, the user terminal 300 displays the selected advertising web page as the second page by using the link information provided from the apparatus 100, in operation S420.

Then, the apparatus 100 provides, to the user terminal 300, the additional data such that the additional contact interface for contacting the advertiser of the selected advertising web page through a contact number on the selected advertising web page is displayed, and the user terminal 300 displays the additional contact interface together with the second page, in operation S430.

Here, the apparatus 100 may provide, as the additional data, information stored according to the selected advertising web page from the DB 170. In other words, the additional data for the additional contact interface may be provided by using information stored in the DB 170, such as contact information included in an advertising web page, a contact method, and arrangement information of a contact interface.

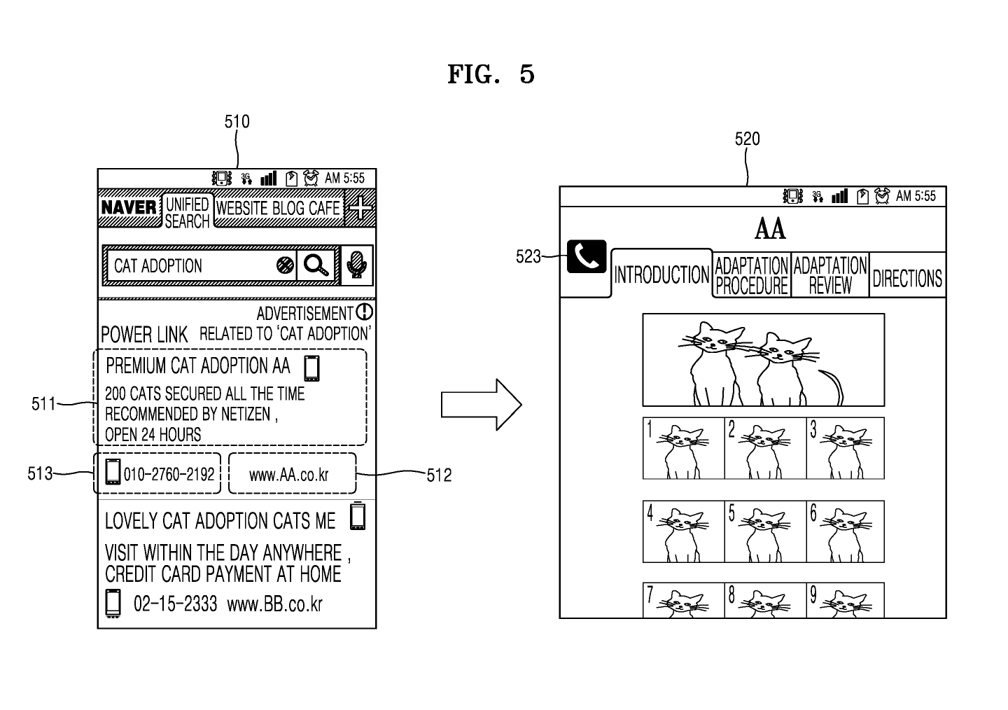

FIG. 5 illustrates a screen of a user terminal 300 of FIG. 1, on which an advertising web page is displayed.

Referring to FIG. 5, a web page list including some information of a plurality of advertising web pages is displayed on the user terminal 300 as a first page 510. Here, the information may include a title and keyword 511, link information 512, and contact information 513.

When the user selects one advertising web page from the web page list by selecting the title and keyword 511 or the link information 512, the screen of the user terminal 300 is switched to the selected advertising web page as a second page 520.

Here, the apparatus 100 provides additional data corresponding to a contact interface provided to enable contact with the advertiser of the selected advertising web page to the user terminal 300, and the user terminal 300 generates a contact interface 523 upon receiving the additional data.

As a result, as shown in FIG. 5, the user terminal 300 displays the selected advertising web page, together with the contact interface 523 to the advertiser of the selected advertising web page on the second page 520. When the user selects the contact interface 523, the contact operation of contacting the advertiser of the selected advertising web page is performed. For example, a phone call operation to a mobile phone of the advertiser may be performed.

By using a method of providing a contact interface, according to one or more embodiments, a user can easily contact an advertiser even within an advertising web page, and thus the inconvenience of the user using the advertising web page may be reduced, and moreover, information about a contact inflow route may be collected even within the advertising web page.

By using an apparatus for providing a contact interface and a method of providing a contact interface by using the apparatus, according to one or more embodiments, even when a user moves to a new advertising web page, an advertiser is contacted just by selecting a contact interface displayed together with the advertising web page, thereby enabling the user to easily use the advertising web page.

Also, by using an apparatus for providing a contact interface and a method of providing a contact interface by using the apparatus, according to one or more embodiments, even when a user moves to a new advertising web page, input information of a contact interface displayed together with the advertising web page is collected to accurately evaluate an advertising effect of the advertising web page and provide benefit to an outstanding advertiser, thereby increasing satisfaction of both the user and an advertiser.

Also, by using an apparatus for providing a contact interface and a method of providing a contact interface by using the apparatus, according to one or more embodiments, when a user contacts an advertiser through a contact interface, a separate guide message is provided to the advertiser such that the advertiser can easily determine an inflow route of the user to the advertiser.

The one or more of the above embodiments may be embodied in the form of a computer program that can be run in a computer through various elements. The computer program may be recorded on a non-transitory computer-readable recording medium. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Furthermore, the non-transitory computer-readable recording medium may be a formless medium that can be transmitted and distributed in a network, e.g., software or an application.

The computer program may be designed and configured specially for the inventive concept or would be obvious to those of ordinary skill in the field of computer software. Examples of the computer program include not only machine language codes prepared by a compiler but also high-level codes executable by a computer by using an interpreter.

The particular implementations shown and described herein are embodiments and are not intended to otherwise limit the scope of the inventive concept in any way. For the sake of brevity, conventional electronics, control systems, software development and other functional aspects of the systems may not be described in detail. Furthermore, the lines or connecting elements shown in the appended drawings are intended to represent exemplary functional relationships and/or physical or logical couplings between the various elements. It should be noted that many alternative or additional functional relationships, physical connections or logical connections may be present in a practical device. Moreover, no item or component is essential to the practice of the inventive concept unless it is specifically described as “essential” or “critical”.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. An apparatus for providing a contact interface, the apparatus comprising:
a web page provider configured to provide a web page list including information of at least one web page to a user terminal; and
an additional contact interface provider configured to, when one of the at least one web page is selected at the user terminal, provide additional data corresponding to an additional contact interface provided to enable contact with an owner of the selected web page, to the user terminal.

2. The apparatus of claim 1, wherein the selected web page is displayed as a different page from the web page list on the user terminal, and
the additional contact interface is displayed on the selected web page as an upper layer of the selected web page.

3. The apparatus of claim 2, wherein the additional data comprises blank information of the selected web page such that the additional contact interface is automatically displayed on a blank region of the selected web page.

4. The apparatus of claim 2, wherein the web page list further comprises a basic contact interface provided to enable contact with each owner of the at least one web page.

5. The apparatus of claim 4, configured to receive history information from the user terminal when a user selects the basic contact interface or the additional contact interface, and provide an inflow route guide message to the owner to notify that the user contacted the owner through the basic contact interface or the additional contact interface.

6. The apparatus of claim 2, wherein the at least one web page is provided through a server separate from the apparatus.

7. A user terminal comprising:
a web page displayer configured to display, as a first web page, a web page list including information of at least one web page by using web page data received from an apparatus for providing a contact interface, and to display, when a user selects one of the at least one web page, as a second page different from the first page, the selected web page; and
an additional contact interface displayer configured to display, as an upper layer of the selected web page on the second page, an additional contact interface provided to enable contact with an owner of the of the selected web page by using additional data received from the apparatus.

8. The user terminal of claim 7, wherein the additional contact interface displayer is further configured to display the additional contact interface on a blank region of the selected web page by using blank information of the selected web page included in the additional data.

9. The user terminal of claim 7, wherein the web page displayer is further configured to display a basic contact interface provided to enable contact with each owner of the at least one web page, together with the first page.

10. The user terminal of claim 9, further comprising a contact operation performer configured to perform a contact operation when the user selects the basic contact interface or the additional contact interface, and transmit history information according to the performing of the contact operation to the apparatus.

11. The user terminal of claim 10, wherein the contact operation is performed via one of a phone call method, an instant message transmitting method, and a mail transmitting method.

12. A method of providing a contact interface on a web page, the method comprising:
providing, by an apparatus for providing a contact interface, web page data including a web page list including information of at least one web page, to a user terminal;
when one of the at least one web page is selected at the user terminal, providing, by the apparatus, second web page data corresponding to the selected web page to the user terminal; and
providing, by the apparatus, additional data corresponding to an additional contact interface provided to enable contact with an owner of the selected web page, to the user terminal.

13. The method of claim 12, wherein the selected web page is displayed as a different web page from the web page list on the user terminal, and
the additional contact interface is displayed as an upper layer of the selected web page on the selected web page.

14. The method of claim 13, wherein the additional data comprises blank information of the selected web page such that the additional contact interface is automatically displayed on a blank region of the selected web page.

15. The method of claim 13, wherein the web page list further comprises a basic contact interface provided to enable contact with each of the at least one web page.

16. The method of claim 15, further comprising:
receiving history information from the user terminal when a user selects the basic contact interface or the additional contact interface; and
providing an inflow route guide message to the owner to notify that the user contacted the owner through the basic contact interface or the additional contact interface.
